(19) United States
(12) Patent Application Publication
(10) Pub. No.: US 2018/0025391 A1
(43) Pub. Date: Jan. 25, 2018

(54) SYSTEMS AND METHODS FOR VEHICLE SERVICING AND VEHICLE VALUE ADJUSTMENTS

(71) Applicant: Kelley Blue Book Co., Inc., Irvine, CA (US)

(72) Inventors: Keely Funkhouser, Atlanta, GA (US); Toshi Mogi, San Francisco, CA (US); Sean Rhodes, San Francisco, CA (US); Alessandra Valenti, San Francisco, CA (US); Geoffrey Schwartz, San Francisco, CA (US); Nelson Wallace, San Francisco, CA (US); Alison Rand, San Francisco, CA (US); Damon Ahola, San Francisco, CA (US); Daniel Holtzman, San Francisco, CA (US); Vivian Kamen, San Francisco, CA (US)

(21) Appl. No.: 15/652,332

(22) Filed: Jul. 18, 2017

Related U.S. Application Data
(60) Provisional application No. 62/366,275, filed on Jul. 25, 2016.

(51) Int. Cl. G06Q 30/02; G06Q 30/06; G06Q 10/00; G07C 5/00

(52) U.S. Cl. CPC G06Q 30/0278; G07C 5/008; G06Q 30/0611; G06Q 30/0631; G06Q 10/20; G06Q 30/0643; G06Q 30/0222

(57) ABSTRACT

Systems, methods, and computer-readable media are disclosed for vehicle servicing and vehicle value adjustments. Example methods may include receiving vehicle registration information comprising a vehicle identification number for a vehicle, determining a first value for the vehicle, and determining vehicle usage data for the vehicle, the vehicle usage data comprising vehicle driving data and vehicle component status. Methods may include determining a first value adjustment for the vehicle based at least in part on the vehicle usage data, determining maintenance information associated with the vehicle, the maintenance comprising vehicle service record data, determining a second value adjustment for the vehicle based at least in part on the maintenance information, and generating a second value for the vehicle based at least in part on the first value, the first value adjustment, and the second value adjustment.

### CROSS-REFERENCE TO RELATED APPLICATION

This application claims the benefit of U.S. Provisional Application No. 62/366,275, filed Jul. 25, 2016, which is hereby incorporated by reference in its entirety.

### BACKGROUND

Vehicle values may fluctuate based on a number of factors, such as geographic location, service history, accident involvement, and other factors. Determining individual vehicle values may be difficult, as specific vehicles may have unique histories or attributes. Further, converting a vehicle value into a vehicle sale may be difficult, as potential buyers may not be aware of vehicles for sale, and potential sellers may not be aware of potential buyers interested in purchasing their vehicles.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is an example process flow for vehicle servicing and vehicle value adjustments in accordance with one or more embodiments of the disclosure.

FIG. 2 is an example process flow for vehicle valuation and transactions in accordance with one or more embodiments of the disclosure.

FIG. 3 is an example user interface for registering a vehicle in accordance with one or more embodiments of the disclosure.

FIGS. 4-5 are example user interfaces for real-time vehicle valuation and vehicle value adjustments in accordance with one or more embodiments of the disclosure.

FIG. 6 is an example user interface for real-time vehicle offers in accordance with one or more embodiments of the disclosure.

FIG. 7 depicts an example computer architecture in accordance with one or more embodiments of the disclosure.

### DETAILED DESCRIPTION

In the following description, numerous specific details are set forth. However, it should be understood that embodiments of the present disclosure may be practiced without these specific details. In other instances, certain methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, the repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “device” refers, in general, to an electronic communication device, both wired and wireless, and more particularly to one or more of the following: a portable electronic device, a telephone (e.g., cellular phone, smartphone), a computer (e.g., laptop computer, tablet computer, desktop computer, wearable computer), a connected camera or viewing device, SmartBoards (e.g., interactive boards), projected/virtual keyboards, motion sensitive systems (e.g., Microsoft Kinect), a portable media player, a personal digital assistant (PDA), a kiosk computer for public use, entertainment/gaming system, web-enabled television or entertainment device, a vehicle, or any other electronic device having a networked capability.

As used herein, unless otherwise specified, the term “server” may refer to any computing device having a networked connectivity and configured to provide one or more dedicated services to clients, such as a mobile device or camera. The services may include storage of data or any kind of data processing. One example of a central server may include a web server hosting one or more web pages. Some examples of web pages may include social networking web pages. Another example of a server may be a cloud server that hosts web services for one or more computer devices.

Embodiments of the disclosure are directed to, among other things, systems and methods for vehicle servicing and vehicle value adjustments. Example embodiments may provide consumers with real-time transparency into a current value of his or her vehicle through connected car data. Real-time market values of vehicles may be calculated using vehicle data, such as vehicle usage data, automatically obtained from a vehicle, such as a connected car. Connected cars may include wireless connectivity, or may be coupled to devices that enable wireless connectivity. Users may enroll in real-time vehicle valuation services generated by embodiments of the disclosure, and sale of a vehicle may be facilitated by certain embodiments.

The systems and methods described herein may generate and present real-time vehicle values based at least in part on vehicle usage data. Certain embodiments may generate an ownership score representative of a vehicle's driving history and/or maintenance data. For example, if a vehicle has been driven aggressively for a majority of its driving, the ownership score may be negatively impacted. Likewise, if a vehicle has been regularly serviced, the ownership score may be positively impacted. Additional factors may include how conservatively or recklessly a vehicle was driven, how often worn parts are replaced or tune-ups are performed, which dealership repaired the vehicle, whether the parts used to repair the vehicle were premium, a number of owners or drivers of the vehicle, etc. Embodiments of the disclosure may facilitate communication between parties interested in buying and/or selling their vehicles. Certain embodiments may generate service recommendations and may generate an estimated resale value impact associated with a particular service. For example, a timing belt replacement may be associated with a $1,000 resale value increase for a particular vehicle. The estimated resale value impact may be valid for a limited time (e.g., a period of 1 year, etc.).

The systems and methods described herein may result in real-time vehicle valuations, transparency into the impact of service and maintenance on vehicle resale value, proactive sales inquiries, and an ability to sort and/or search for vehicles with certain maintenance records and/or certain condition. Using embodiments of the disclosure, users may receive information relating to how service impacts resale value for their vehicles, and may seamlessly sell their vehicles. Dealerships may continuously engage customers through servicing and selling notifications, and may experience reduced customer acquisition costs due to repeat purchasing. Customer retention may also be increased for vehicle servicing. Dealer lot inventory may be reduced and vehicle sale commission opportunities may be increased.

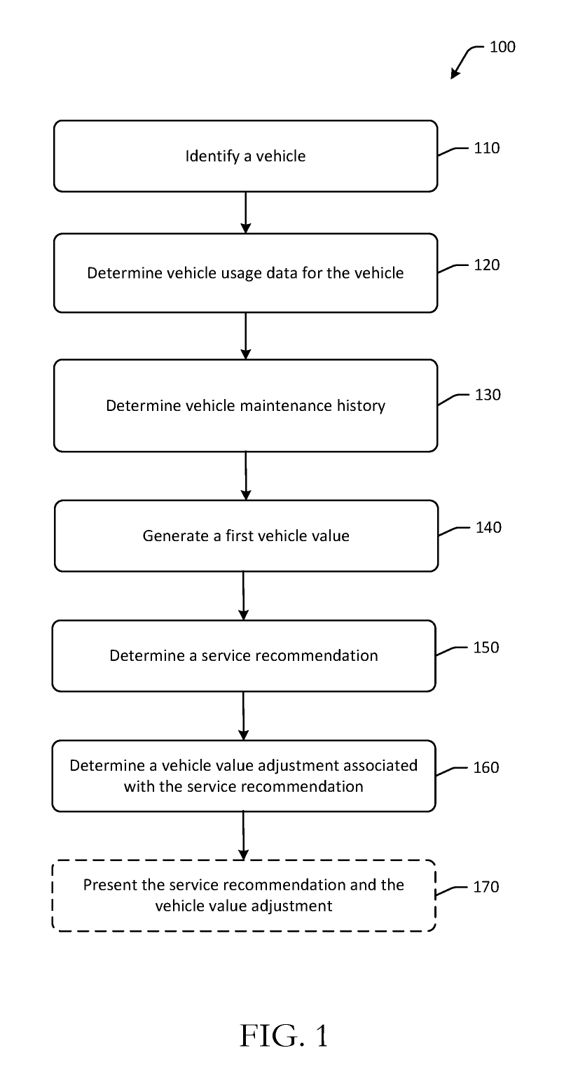

Referring now to FIG. 1, an example process flow 100 for vehicle servicing and vehicle value adjustments is depicted in accordance with one or more embodiments of the disclosure. At block 110, a vehicle may be identified. Vehicles may be identified by a vehicle identifier, such as a vehicle identification number. In some embodiments, users may register or enroll in a service by providing a vehicle identifier. The vehicle may be associated with a user profile or a user account.

At block 120, vehicle usage data for the vehicle is determined. Vehicle usage data may include a driving history representing usage of the vehicle. For example, vehicle usage data may include a length of time the vehicle has been used, mileage information, and specific usage information such as a number of hard braking or rapid acceleration incidents, average braking distance, average acceleration intensity, average speed, a driver rating indicative of whether or how often the vehicle was driven in a certain manner (e.g., conservative, average, rough, etc.), and other data. Vehicle usage data may also include vehicle component status information. Vehicle usage data may be received wirelessly from the vehicle, for example, via an onboard computer, or may be received from a device coupled to the vehicle, such as a removable electronic device. Vehicle usage data may be used to determine component status for various vehicle components. In some embodiments, a wear and tear score may be determined for various vehicle components. For example, a wear and tear score of 90% may be generated for front brake pads based at least in part on usage and maintenance history. Determining vehicle usage data may include filtering data and selecting a portion of available data for processing.

In one embodiment, vehicle usage data may be captured via a vehicle data logging device. The vehicle data logging device may be in communication with a mobile application that can be accessed by one or more parties, such as vehicle owners, dealerships, other users, such as potential buyers, and the like. The vehicle data logging device may be coupled to the vehicle and may store or otherwise capture discrete driving and maintenance data. Vehicle usage data may reflect operational characteristics such as typical speed, acceleration, and braking behaviors by drivers of the vehicle. Additional factors may include how conservatively or recklessly a vehicle was driven, how often worn parts are replaced or tune-ups are performed, which dealership repaired the vehicle, whether the parts used to repair the vehicle were premium, a number of owners or drivers of the vehicle, etc. Vehicle usage data may include vehicle error codes that may be determined by vehicle components or by external devices. Vehicle error codes may be communicated to vehicle owners, for example at a mobile device user interface, to dealers, and/or to third parties. Vehicle owners may schedule service to resolve error codes via the mobile application. Dealers may proactively send messages and/or notifications to vehicle owners to schedule service to resolve error codes, thereby reducing actions needed by the user to address vehicle error codes.

At block 130, a vehicle maintenance history is determined. The vehicle maintenance history may include completed vehicle services, as well as frequency of service, date of last service, a determination of whether recommended service has been completed and/or verified, and other information. Vehicle maintenance data may be automatically retrieved, for example, from dealership service records, repair shop service records, or may be manually entered by a user and verified.

In some embodiments, an ownership score may be determined for a vehicle. Ownership scores may represent an alphanumeric value based at least in part on one or both the vehicle usage data and the vehicle maintenance history.

At block 140, a first vehicle value is determined. The first vehicle value may be determined for the vehicle based at least in part on the vehicle usage history, the vehicle maintenance history, and/or other factors, including geographic location, make, model, year, and other factors. Vehicle values may be broadcast to third parties that may be interested in purchasing the vehicle. Vehicle values may also be determined based on a vehicle history report, such as collision records, registration records, emissions records, maintenance records, and other information that may be received from or otherwise determined from third parties.

At block 150, a service recommendation is determined. Service recommendations may be determined for specific vehicles and may be based at least in part on the vehicle make, model, mileage, manufacturer recommended service, component status, and/or vehicle usage history. For example, a service recommendation of “replace timing belt” may be determined.

At block 160, a vehicle value adjustment associated with the service recommendation is determined. The vehicle value adjustment may be specific to the vehicle and the recommended service. For example, the “replace timing belt” service may be associated with a $1,000 increase in resale value, or a vehicle value adjustment of +$1,000 for the vehicle. The vehicle value adjustment may be valid for a certain timeframe, such as one year. In some embodiments, the vehicle value adjustment may be determined in addition to a current vehicle value. For example, if the vehicle is currently worth $10,000, the timing belt replacement service may increase the vehicle value to $11,000. In certain instances, failure to perform a recommended service, such as an oil change, may negatively impact resale value, and the vehicle value adjustment may therefore be negative. The vehicle value adjustment may be implemented if service is not performed within a predetermined timeframe. Users may therefore be aware of a real-time value of their vehicle, as well as an impact on resale value of their vehicle for certain services. Users may therefore make informed decisions when determining whether to complete recommended services.

In some embodiments, completion of service recommendations, or failure to complete service recommendations, may impact the ownership score for a vehicle instead of, or in addition to, impacting the vehicle value. For example, if an oil change is a recommended service, an ownership score for a vehicle that was previously 94 may drop to a 93. The ownership score may drop at the time the vehicle owner is notified of the recommended service, or a period of time thereafter. Upon completion of the recommended service, the ownership score may return to a 94. Performing timely maintenance on the vehicle may reduce the speed at which the vehicle depreciates over time, and may slow wear and tear of vehicle components, thereby increasing a quality of the vehicle and overall condition of the vehicle. Depending on the severity of the service that is recommended, and the condition of vehicle components, a change in ownership score may correspond to the recommended service. For example, if timing belt replacement is recommended, the ownership score may drop 10 points until the service is complete. If the condition of the timing belt replacement deteriorates further, another drop in ownership score may be implemented until the service is complete. However, if the service is not completed within a certain predetermined time frame or predetermined number of miles or operation hours, or the condition worsens before completion of service, the ownership score may not return to the original score. For example, rather than returning to a 94, the score may go to 87 after the timing belt is replaced if not completed in a timely manner. Vehicle values and/or lease rates may be impacted by ownership scores, for example, at the time of grounding. Inspection and valuation process after grounding may also be expedited as vehicle usage data and/or ownership score may be available before the leased vehicle is returned.

At optional block 170, the service recommendation and the vehicle value adjustment may be presented, for example, at a user device. In certain embodiments, users may be able to schedule recommended service via a user interface generated at the user device, and may also be able to accept or reject recommended services using the user device. Promotional offers may also be generated for users.

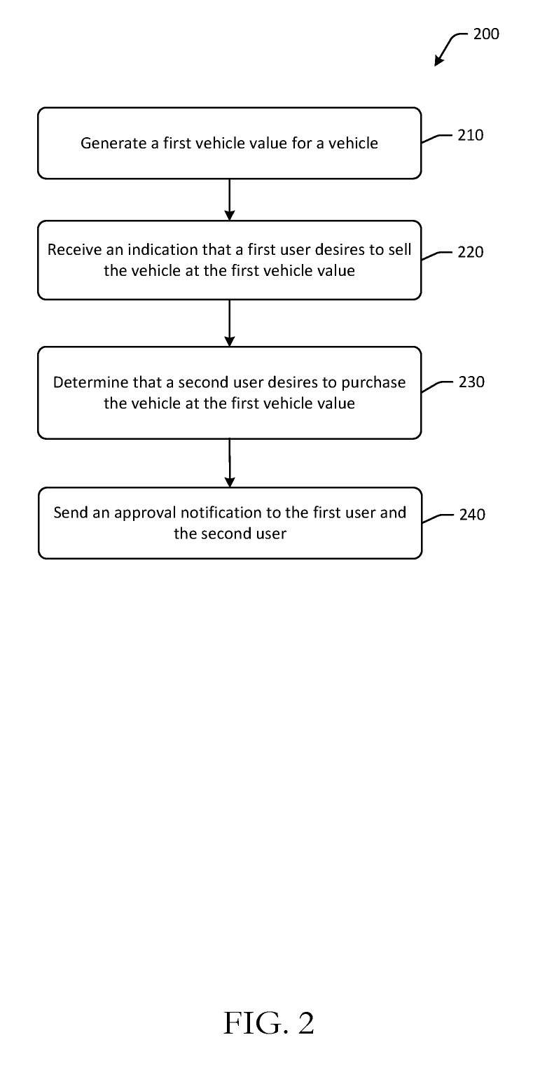

Referring to FIG. 2, an example process flow 200 for vehicle valuation and transactions is depicted in accordance with one or more embodiments of the disclosure. At block 210, a first vehicle value for a vehicle is generated. The first vehicle value may be based at least in part on make and model, mileage, location, vehicle usage history, vehicle maintenance history, and/or other factors. At block 220, an indication that a first user desires to sell the vehicle at the first vehicle value may be received. For example, the first user may receive a notification of a current vehicle value with an option to indicate that the first user is interested in selling the vehicle. At block 230, a determination is made that a second user desires to purchase the vehicle at the first vehicle value. For example, the second user may be offered the vehicle at the first vehicle value via a user interface. The second user may indicate a desire to purchase the vehicle via a selectable element on the user interface. At block 240, an approval notification may be sent to the first user and to the second user. The first user and the second user may meet at a dealership to facilitate sale of the vehicle. The second user may have a more transparent view into the vehicle's history than otherwise available, due to the vehicle usage data and the maintenance data, and the first user may benefit from proper maintenance and care of the vehicle via an increased resale price.

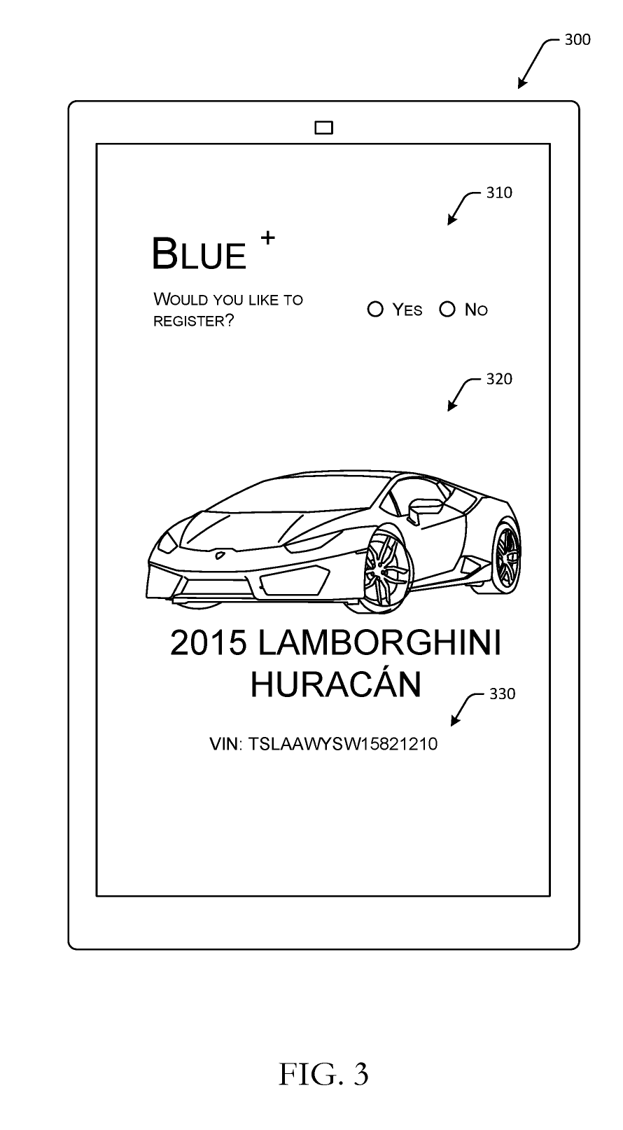

Referring now to FIG. 3, an example user interface 300 for registering a vehicle is depicted in accordance with one or more embodiments of the disclosure. The user interface 300 may include an option to register a vehicle 310 or otherwise opt-in to the service, as well as vehicle information for the vehicle to be registered, such as a vehicle image 320 and a vehicle identifier 330, such as a vehicle identification number. The vehicle image 320 may be a stock vehicle image or may be an image captured by a vehicle owner of a particular vehicle being registered.

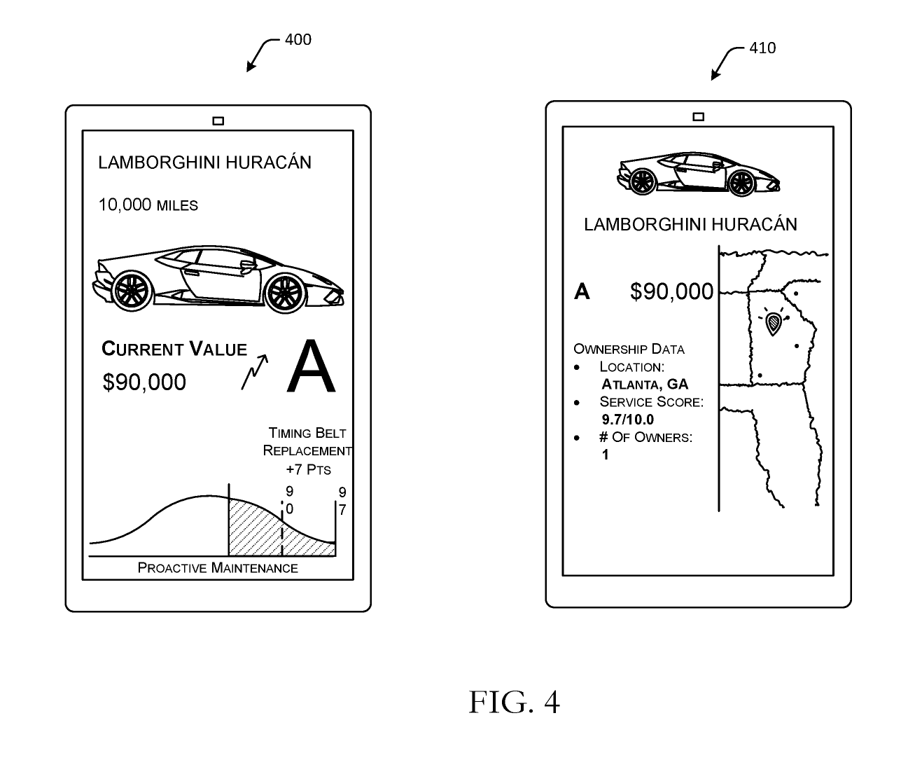

Referring now to FIG. 4, example user interfaces for real-time vehicle valuation and vehicle value adjustments in accordance with one or more embodiments of the disclosure are depicted. A first user interface 400 includes an information dashboard. The information dashboard may include vehicle information such as a make and model of a vehicle, current mileage, current value, and a current ownership score. For example, the current value of a vehicle, such as a Lamborghini Huracan may be $90,000. The vehicle may currently have 10,000 miles. Current values for vehicles may be determined based at least in part on vehicle type, vehicle condition, mileage, ownership score, service history, and/or other factors. The ownership score in FIG. 4 may be “A” on a scale of A to F. The ownership score may correspond to a numerical value or range of values (e.g., 90-100=A, 80-89=B, etc.). Ownership scores may also be determined as numeric values, alphanumeric values, or another metric indicative of the vehicle's ownership. An arrow indicator may indicate a vehicle value trend. For example, in FIG. 4, the Lamborghini's value may be trending upwards, or increasing, due to preventative maintenance performance, timely servicing, cautious driving, and/or other factors. The information dashboard may include a graphical indicator that shows how much an ownership score may be adjusted based at least in part on certain actions being performed. For example, if a timing belt is replaced on the Lamborghini, the ownership score may increase by 7 points from 90-97. The graph may represent available proactive maintenance tasks that can be performed.

A second user interface 410 may provide additional information used to calculate the Lamborghini's current value. For example, the vehicle's location in Atlanta, Ga. may factor into the vehicle's current value. A service score may indicate timeliness and completeness of recommended and/or required vehicle servicing. The service score may factor into the vehicle's current value and may be determined based at least in part on verified service records. A number of owners of the vehicle may impact the current value and/or ownership score.

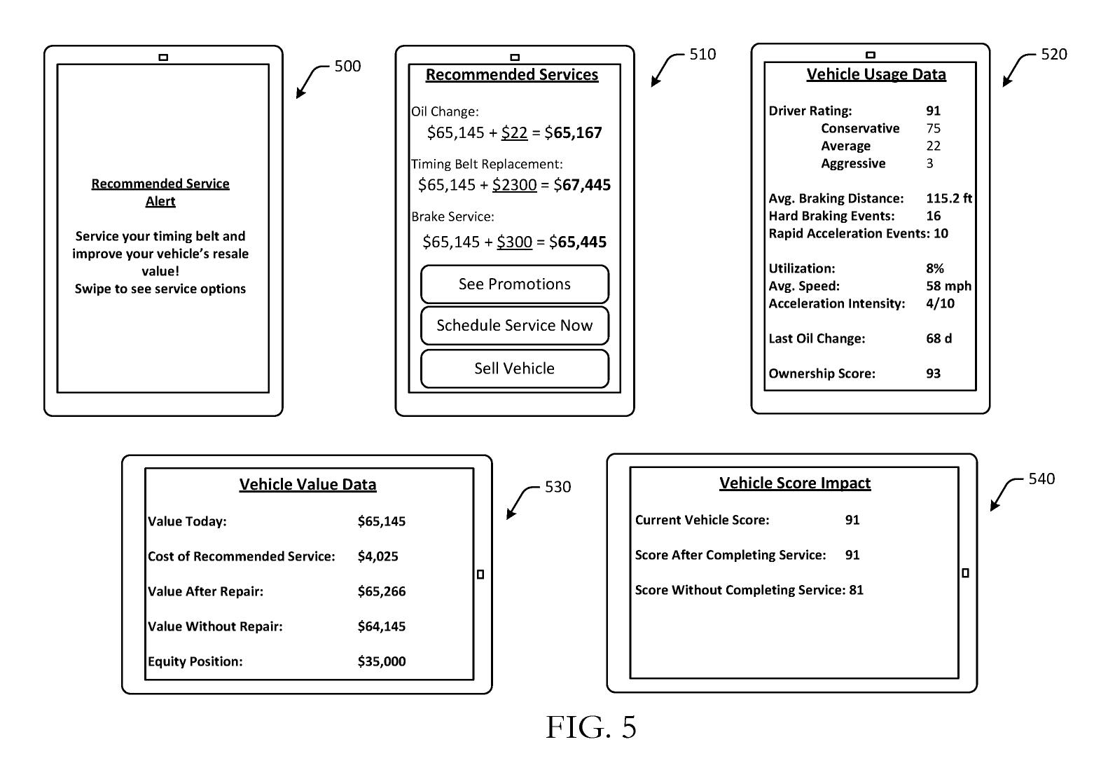

Referring now to FIG. 5, example user interfaces for recommended vehicle servicing and vehicle usage data are depicted in accordance with one or more embodiments of the disclosure. At a first user interface 500, recommended service alerts may be determined and/or presented at a user device. The recommended service alert may provide information related to recommended vehicle services. Recommended services may be determined based at least in part on manufacturer provided information and/or usage of a vehicle and vehicle component statuses. In the example first user interface 500, a recommended vehicle service of timing belt servicing may be presented at a user device.

At a second user interface 510, vehicle value adjustment information may be presented. For example, three services may be recommended for a vehicle: (i) an oil change; (ii) timing belt replacement; and (iii) brake service. One or more of the recommended services may be associated with an adjustment in vehicle value. Adjustments may be positive or negative. For example, if a service is not performed within a certain timeframe, the vehicle value may be negatively affected by the amount of the potential increase had the vehicle been timely serviced. In the example of FIG. 5, an oil change may increase a vehicle value by $22, the timing belt servicing may increase the vehicle value by $2,300, and the brake service may increase the vehicle value by $300. Vehicle value adjustments may be vehicle specific and may be based at least in part on service cost, service history, need for a service (e.g., is service required immediately?, etc.), and/or other factors. Options to schedule one or more services, receive promotions on recommended services, and/or to sell a vehicle may be presented at the second user interface 510. In other embodiments, ownership scores and the respective impact of service may be presented instead of, or in addition to, vehicle value impact.

A third user interface 520 may present vehicle usage data. The vehicle usage data may include a driver rating and other information determined based at least in part on the usage of the vehicle. Service recommendations, vehicle values, and vehicle value adjustments may be determined based at least in part on the vehicle usage data. In the example of FIG. 5, the driver rating may be 91/100. The driver rating may include a breakdown of conservative, average, and aggressive use of the vehicle. Use of the vehicle may be determined to be conservative, average, or aggressive based at least in part on factors such as aggressive braking or acceleration, hard braking events, braking distance, and the like. The vehicle of FIG. 5 may have been driven conservatively 75% of the time, average 22% of the time, and aggressive 3% of the time, resulting in a driver rating of 91/100. The average braking distance of 115.2 feet, the 16 hard braking events, and the 10 rapid acceleration events may impact the driver rating and/or ownership score. Vehicle usage data may include additional information such as utilization, average speed, average acceleration intensity, location of use, average speed of driving segments, idling time, braking frequency, tire or other component wear, date since last servicing, such as oil change, and an ownership score, which may be impacted by the driver rating and maintenance history.

A fourth user interface 530 may provide data to assist vehicle owners in making decisions regarding repairs. For example, a current vehicle value may be presented to the user, along with an estimated cost of a certain repair. The vehicle values after the repair and without the repair may also be presented to the user. Using the presented information, the user may make an informed decision regarding whether or not to complete a repair, or to seek an alternative solution, such as selling the vehicle or trading the vehicle into a dealer. In the example of FIG. 5, if a repair will cost $4,025, and the vehicle value after the repair is only going to be $120 greater than the current value, and the vehicle value without the repair is $1,000 less than the current value, the user may decide not to complete the repair. An equity position may also be presented to illustrate to a vehicle owner their equity position in a vehicle.

In another example, at a fifth user interface 540, a vehicle score impact screen may be presented to a user indicating an impact on a vehicle score or an ownership score. The vehicle score may indicate an overall condition of the engine and/or usage of the vehicle. The information presented may allow vehicle owners to determine an impact of service on the vehicle score, and to make informed decisions about service. For example, a vehicle owner may be encouraged to perform timely service on a vehicle to maintain a relatively high vehicle score.

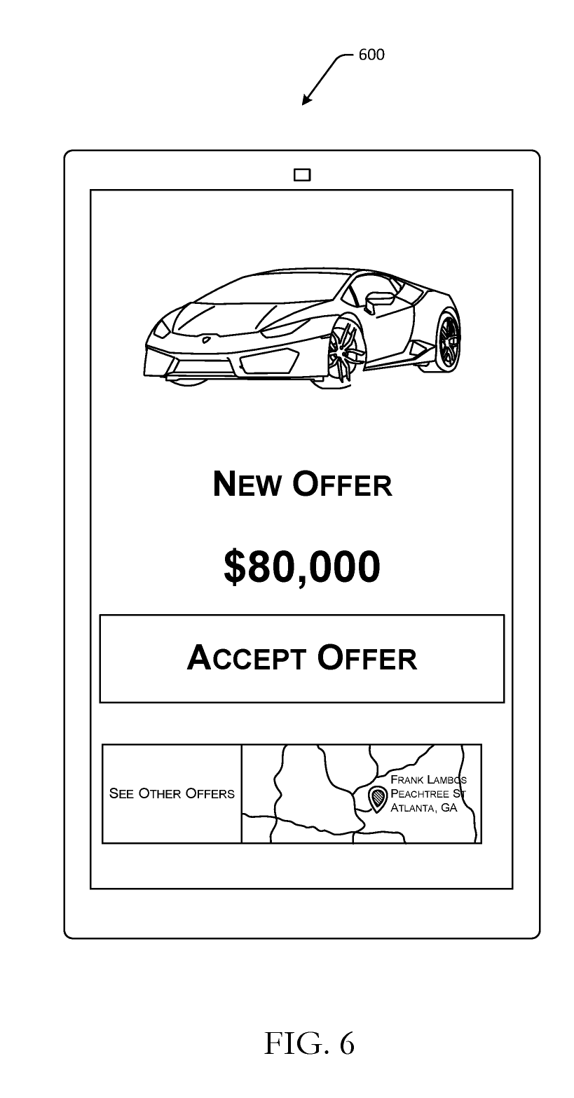

Referring now to FIG. 6, an example user interface 600 for presenting an offer to purchase a vehicle is depicted in accordance with one or more embodiments of the disclosure. For example, an offer of $80,000 for the Lamborghini may be presented at a user device. Accordingly, a vehicle owner may be able to sell his or her vehicle at any time, and may receive offers from another party to purchase the user's vehicle at any time. The user may receive an offer value and a location at which the user may facilitate sale of the vehicle. The location may be a dealership, and the dealership may facilitate the vehicle sale. In some embodiments, a digital marketplace may be provided in which users may view details and valuations of other vehicles registered at the marketplace, and may make offers directly to vehicle owners based at least in part on the vehicle valuation. In some embodiments, offers for vehicles may be facilitated via dealerships. Similarly, dealers can make unsolicited offers directly to vehicle owners without proactive actions taken by the vehicle owner. Dealers or other users may be able to determine a condition of the vehicle, condition of vehicle components, maintenance history, service history, and other information via the digital marketplace platform, and can make better informed decisions and offers as a result thereof.

The above-described systems and methods may result in real-time vehicle valuations, transparency into the impact of service and maintenance on vehicle resale value, proactive sales inquiries, and an ability to sort and/or search for vehicles with certain maintenance records and/or certain condition. Using embodiments of the disclosure, users may receive information relating to how service impacts resale value for their vehicles, and may seamlessly sell their vehicles. Dealerships may continuously engage customers through servicing and selling notifications, and may experience reduced customer acquisition costs due to repeat purchasing. Dealer lot inventory may be reduced and vehicle sale commission opportunities may be increased.

One or more operations of the process flows 100, 200 may have been described above as being performed by a computer system, or more specifically, by one or more program modules, applications, or the like executing on a device. It should be appreciated, however, that any of the operations of process flows 100, 200 may be performed, at least in part, in a distributed manner by one or more other devices, or more specifically, by one or more program modules, applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. The operations described and depicted in the illustrative process flows 100, 200 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in process flows 100, 200 may be performed.

### Illustrative Computer Architecture

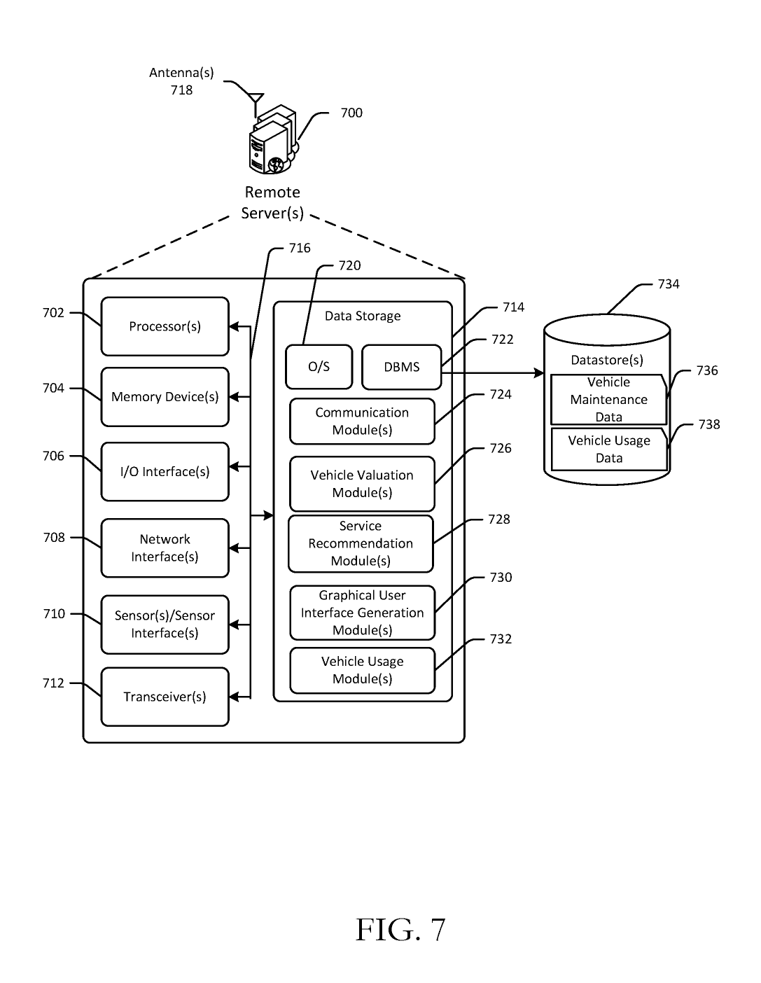

FIG. 7 is a schematic block diagram of one or more illustrative remote server(s) 700 in accordance with one or more example embodiments of the disclosure. The remote server(s) 700 may include any suitable computing device capable of receiving and/or generating audio including, but not limited to, a server system, a mobile device such as a smartphone, tablet, e-reader, wearable device, or the like; a desktop computer; a laptop computer; a content streaming device; a set-top box; or the like. The remote server(s) 700 may correspond to an illustrative device configuration for the campaign management servers of FIGS. 1-6.

The remote server(s) 700 may be configured to communicate via one or more networks with one or more servers, user devices, or the like. The remote server(s) 700 may be configured to determine vehicle valuations and/or facilitate vehicle transactions. In some embodiments, a single remote server or single group of remote servers may be configured to perform more than one type of content delivery functionality.

The remote server(s) 700 may be configured to communicate via one or more networks. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the remote server(s) 700 may include one or more processors (processor(s)) 702, one or more memory devices 704 (generically referred to herein as memory 704), one or more input/output (“I/O”) interface(s) 706, one or more network interface(s) 708, one or more sensors or sensor interface(s) 710, one or more transceivers 712, and data storage 714. The remote server(s) 700 may further include one or more buses 716 that functionally couple various components of the remote server(s) 700. The remote server(s) 700 may further include one or more antenna(e) 718 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 716 may include at least one of a system bus, a memory bus, an address bus, or a message bus, and may permit exchange of information (e.g., data (including computer-executable code), signaling, etc.) between various components of the remote server(s) 700. The bus(es) 716 may include, without limitation, a memory bus or a memory controller, a peripheral bus, an accelerated graphics port, and so forth. The bus(es) 716 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 704 of the remote server(s) 700 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth.

Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 704 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 704 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 714 may include removable storage and/or non-removable storage including, but not limited to, magnetic storage, optical disk storage, and/or tape storage. The data storage 714 may provide non-volatile storage of computer-executable instructions and other data. The memory 704 and the data storage 714, removable and/or non-removable, are examples of computer-readable storage media (CRSM) as that term is used herein.

The data storage 714 may store computer-executable code, instructions, or the like that may be loadable into the memory 704 and executable by the processor(s) 702 to cause the processor(s) 702 to perform or initiate various operations. The data storage 714 may additionally store data that may be copied to memory 704 for use by the processor(s) 702 during the execution of the computer-executable instructions. Moreover, output data generated as a result of execution of the computer-executable instructions by the processor(s) 702 may be stored initially in memory 704, and may ultimately be copied to data storage 714 for non-volatile storage.

More specifically, the data storage 714 may store one or more operating systems (O/S) 720; one or more database management systems (DBMS) 722; and one or more program module(s), applications, engines, computer-executable code, scripts, or the like such as, for example, one or more communication module(s) 724, one or more vehicle valuation module(s) 726, one or more service recommendation module(s) 728, one or more graphical user interface generation module(s) 730, and/or one or more vehicle usage module(s) 732. Some or all of these module(s) may be sub-module(s). Any of the components depicted as being stored in data storage 714 may include any combination of software, firmware, and/or hardware. The software and/or firmware may include computer-executable code, instructions, or the like that may be loaded into the memory 704 for execution by one or more of the processor(s) 702. Any of the components depicted as being stored in data storage 714 may support functionality described in reference to correspondingly named components earlier in this disclosure.

The data storage 714 may further store various types of data utilized by components of the remote server(s) 700. Any data stored in the data storage 714 may be loaded into the memory 704 for use by the processor(s) 702 in executing computer-executable code. In addition, any data depicted as being stored in the data storage 714 may potentially be stored in one or more datastore(s) and may be accessed via the DBMS 722 and loaded in the memory 704 for use by the processor(s) 702 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 7, an example datastore(s) 734 may include, for example, vehicle maintenance data 736, vehicle usage data 738, and other information.

The processor(s) 702 may be configured to access the memory 704 and execute computer-executable instructions loaded therein. For example, the processor(s) 702 may be configured to execute computer-executable instructions of the various program module(s), applications, engines, or the like of the remote server(s) 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 702 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 702 may be capable of supporting any of a variety of instruction sets.

Referring now to functionality supported by the various program module(s) depicted in FIG. 7, the communication module(s) 724 may include computer-executable instructions, code, or the like that responsive to execution by one or more of the processor(s) 702 may perform functions including, but not limited to, communicating with remote servers, communicating with remote datastores, sending or receiving notifications, and the like.

The vehicle valuation module(s) 726 may include computer-executable instructions, code, or the like that responsive to execution by one or more of the processor(s) 702 may perform functions including, but not limited to, determining current vehicle values, determining estimated vehicle value adjustments, determining resale value, determining loan balance information, and the like.

The service recommendation module(s) 728 may include computer-executable instructions, code, or the like that responsive to execution by one or more of the processor(s) 702 may perform functions including, but not limited to, determining vehicle service recommendations, determining vehicle component status, and the like.

The graphical user interface generation module(s) 730 may include computer-executable instructions, code, or the like that responsive to execution by one or more of the processor(s) 702 may perform functions including, but not limited to, identifying device properties, determining user interface formatting, determining graphical indicator contents and formatting, and the like.

The vehicle usage module(s) 732 may include computer-executable instructions, code, or the like that responsive to execution by one or more of the processor(s) 702 may perform functions including, but not limited to, determining vehicle usage data, communicating with connected vehicles, analyzing received usage data, and the like.

Referring now to other illustrative components depicted as being stored in the data storage 714, the O/S 720 may be loaded from the data storage 714 into the memory 704 and may provide an interface between other application software executing on the remote server(s) 700 and hardware resources of the remote server(s) 700. More specifically, the O/S 720 may include a set of computer-executable instructions for managing hardware resources of the remote server(s) 700 and for providing common services to other application programs (e.g., managing memory allocation among various application programs). In certain example embodiments, the O/S 720 may control execution of the other program module(s) to dynamically enhance characters for content rendering. The O/S 720 may include any operating system now known or which may be developed in the future including, but not limited to, any server operating system, any mainframe operating system, or any other proprietary or non-proprietary operating system.

The DBMS 722 may be loaded into the memory 704 and may support functionality for accessing, retrieving, storing, and/or manipulating data stored in the memory 704 and/or data stored in the data storage 714. The DBMS 722 may use any of a variety of database models (e.g., relational model, object model, etc.) and may support any of a variety of query languages. The DBMS 722 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the remote server(s) 700 is a mobile device, the DBMS 722 may be any suitable light-weight DBMS optimized for performance on a mobile device.

Referring now to other illustrative components depicted as being stored in the data storage 714, the O/S 720 may be loaded from the data storage 714 into the memory 704 and may provide an interface between other application software executing on the remote server(s) 700 and hardware resources of the remote server(s) 700. More specifically, the O/S 720 may include a set of computer-executable instructions for managing hardware resources of the remote server(s) 700 and for providing common services to other application programs (e.g., managing memory allocation among various application programs). In certain example embodiments, the O/S 720 may control execution of one or more of the program module(s) depicted as being stored in the data storage 714. The O/S 720 may include any operating system now known or which may be developed in the future including, but not limited to, any server operating system, any mainframe operating system, or any other proprietary or non-proprietary operating system.

The DBMS 722 may be loaded into the memory 704 and may support functionality for accessing, retrieving, storing, and/or manipulating data stored in the memory 704 and/or data stored in the data storage 714. The DBMS 722 may use any of a variety of database models (e.g., relational model, object model, etc.) and may support any of a variety of query languages. The DBMS 722 may access data represented in one or more data schemas and stored in any suitable data repository. In certain example embodiments, the DBMS 722 may be any suitable light-weight DBMS optimized for performance on a mobile device.

Referring now to other illustrative components of the remote server(s) 700, the input/output (I/O) interface(s) 706 may facilitate the receipt of input information by the remote server(s) 700 from one or more I/O devices as well as the output of information from the remote server(s) 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the remote server(s) 700 or may be separate. The I/O devices may further include, for example, any number of peripheral devices such as data storage devices, printing devices, and so forth.

The I/O interface(s) 706 may also include an interface for an external peripheral device connection such as universal serial bus (USB), FireWire, Thunderbolt, Ethernet port or other connection protocol that may connect to one or more networks. The I/O interface(s) 706 may also include a connection to one or more of the antenna(e) 718 to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The remote server(s) 700 may further include one or more network interface(s) 708 via which the remote server(s) 700 may communicate with any of a variety of other systems, platforms, networks, devices, and so forth. The network interface(s) 708 may enable communication, for example, with one or more wireless routers, one or more host servers, one or more web servers, and the like via one or more of networks.

The antenna(e) 718 may include any suitable type of antenna depending, for example, on the communications protocols used to transmit or receive signals via the antenna(e) 718. Non-limiting examples of suitable antennas may include directional antennas, non-directional antennas, dipole antennas, folded dipole antennas, patch antennas, multiple-input multiple-output (MIMO) antennas, or the like. The antenna(e) 718 may be communicatively coupled to one or more transceivers 712 or radio components to which or from which signals may be transmitted or received.

As previously described, the antenna(e) 718 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 718 may additionally, or alternatively, include a Wi-Fi antenna configured to transmit or receive signals in accordance with established standards and protocols, such as the IEEE 1002.11 family of standards, including via 2.4 GHz channels (e.g. 1002.11b, 1002.11g, 1002.11n), 5 GHz channels (e.g. 1002.11n, 1002.11ac), or 60 GHZ channels (e.g. 1002.11ad). In alternative example embodiments, the antenna(e) 718 may be configured to transmit or receive radio frequency signals within any suitable frequency range forming part of the unlicensed portion of the radio spectrum.

The antenna(e) 718 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 712 may include any suitable radio component(s) for—in cooperation with the antenna(e) 718—transmitting or receiving radio frequency (RF) signals in the bandwidth and/or channels corresponding to the communications protocols utilized by the remote server(s) 700 to communicate with other devices. The transceiver(s) 712 may include hardware, software, and/or firmware for modulating, transmitting, or receiving—potentially in cooperation with any of antenna(e) 718—communications signals according to any of the communications protocols discussed above including, but not limited to, one or more Wi-Fi and/or Wi-Fi direct protocols, as standardized by the IEEE 1002.11 standards, one or more non-Wi-Fi protocols, or one or more cellular communications protocols or standards. The transceiver(s) 712 may further include hardware, firmware, or software for receiving GNSS signals. The transceiver(s) 712 may include any known receiver and baseband suitable for communicating via the communications protocols utilized by the remote server(s) 700. The transceiver(s) 712 may further include a low noise amplifier (LNA), additional signal amplifiers, an analog-to-digital (A/D) converter, one or more buffers, a digital baseband, or the like.

The sensor(s)/sensor interface(s) 710 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth.

It should be appreciated that the program module(s), applications, computer-executable instructions, code, or the like depicted in FIG. 7 as being stored in the data storage 714 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the remote server(s) 700, and/or hosted on other computing device(s) accessible via one or more networks, may be provided to support functionality provided by the program module(s), applications, or computer-executable code depicted in FIG. 7 and/or additional or alternate functionality. Further, functionality may be modularized differently such that processing described as being supported collectively by the collection of program module(s) depicted in FIG. 7 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 7 may be implemented, at least partially, in hardware and/or firmware across any number of devices.

It should further be appreciated that the remote server(s) 700 may include alternate and/or additional hardware, software, or firmware components beyond those described or depicted without departing from the scope of the disclosure. More particularly, it should be appreciated that software, firmware, or hardware components depicted as forming part of the remote server(s) 700 are merely illustrative and that some components may not be present or additional components may be provided in various embodiments. While various illustrative program module(s) have been depicted and described as software module(s) stored in data storage 714, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-6 may be performed by a device having the illustrative configuration depicted in FIG. 7, or more specifically, by one or more engines, program module(s), applications, or the like executable on such a device. It should be appreciated, however, that such operations may be implemented in connection with numerous other device configurations.

The operations described and depicted in the illustrative methods and process flows of FIGS. 1-6 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-6 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed:

1. A method comprising:
receiving, by one or more computer processors coupled to at least one memory device, vehicle registration information comprising a vehicle identification number for a vehicle;
determining a first value for the vehicle;
determining vehicle usage data for the vehicle, the vehicle usage data comprising vehicle driving data and vehicle component status;
determining a first value adjustment for the vehicle based at least in part on the vehicle usage data;
determining maintenance information associated with the vehicle, the maintenance comprising vehicle service record data;
determining a second value adjustment for the vehicle based at least in part on the maintenance information; and
generating a second value for the vehicle based at least in part on the first value, the first value adjustment, and the second value adjustment.

2. The method of claim 1, further comprising:
presenting the second value via a device display; and
presenting an offer to purchase the vehicle at the second value.

3. The method of claim 1, further comprising:
determining a service recommendation for a vehicle service based at least in part on the vehicle usage data or the maintenance information;
determining a third value adjustment for the vehicle after completion of the vehicle service; and
presenting the third value adjustment and a promotional offer for the vehicle service.

4. The method of claim 3, further comprising:
receiving confirmation of completion of the vehicle service; and
generating a third value for the vehicle based at least in part on the second value and the third value adjustment.

5. The method of claim 1, further comprising determining a wear and tear score for the vehicle based at least in part on the vehicle usage data.

6. The method of claim 1, further comprising:
receiving an indication that a first user desires to sell the vehicle at the second value;
determining that a second user desires to purchase the vehicle at the second value; and
sending an approval notification to the first user and the second user.

7. The method of claim 1, wherein the vehicle usage data is received from a device onboard the vehicle.

8. A device comprising:
at least one memory that stores computer-executable instructions;
at least one processor configured to access the at least one memory and execute the computer-executable instructions to:
receive vehicle registration information comprising a vehicle identification number for a vehicle;
determine a first value for the vehicle;
determine vehicle usage data for the vehicle, the vehicle usage data comprising vehicle driving data and vehicle component status;
determine a first value adjustment for the vehicle based at least in part on the vehicle usage data;
determine maintenance information associated with the vehicle, the maintenance comprising vehicle service record data;
determine a second value adjustment for the vehicle based at least in part on the maintenance information; and
generate a second value for the vehicle based at least in part on the first value, the first value adjustment, and the second value adjustment.

9. The device of claim 8, wherein the at least one processor is further configured to access the at least one memory and execute the computer-executable instructions to:
present the second value via a device display; and
present an offer to purchase the vehicle at the second value.

10. The device of claim 8, wherein the at least one processor is further configured to access the at least one memory and execute the computer-executable instructions to:
determine a service recommendation for a vehicle service based at least in part on the vehicle usage data or the maintenance information;
determine a third value adjustment for the vehicle after completion of the vehicle service; and
present the third value adjustment and a promotional offer for the vehicle service.

11. The device of claim 10, wherein the at least one processor is further configured to access the at least one memory and execute the computer-executable instructions to:
receive confirmation of completion of the vehicle service; and
generate a third value for the vehicle based at least in part on the second value and the third value adjustment.

12. The device of claim 8, wherein the at least one processor is further configured to access the at least one memory and execute the computer-executable instructions to:
determine a wear and tear score for the vehicle based at least in part on the vehicle usage data.

13. The device of claim 8, wherein the at least one processor is further configured to access the at least one memory and execute the computer-executable instructions to:
receive an indication that a first user desires to sell the vehicle at the second value;
determine that a second user desires to purchase the vehicle at the second value; and
send an approval notification to the first user and the second user.

14. The device of claim 8, wherein the vehicle usage data is received from a device onboard the vehicle.

15. A method comprising:
determining, by one or more computer processors coupled to at least one memory, vehicle usage data for a vehicle associated with a first user;
determining a current vehicle value for the vehicle based at least in part on the vehicle usage data;
determining a second user interested in purchasing the vehicle at the current vehicle value;
sending a vehicle sale notification to the first user; and
sending location information to the first user and to the second user to facilitate sale of the vehicle.

16. The method of claim 15, further comprising:
determining a recommended service for the vehicle based at least in part on the vehicle usage data; and
determining a vehicle value adjustment associated with the recommended service.

17. The method of claim 16, further comprising:
determining that the recommended service is complete; and
increasing the current vehicle value by the vehicle value adjustment.

18. The method of claim 16, further comprising scheduling the recommended service.

19. The method of claim 16, further comprising determining a promotion associated with the recommended service.

20. The method of claim 15, further comprising receiving confirmation of the vehicle sale.
